(19) United States
(12) Patent Application Publication
(10) Pub. No.: US 2004/0218065 A1
(43) Pub. Date: Nov. 4, 2004

(54) Personality modes in a handheld electronic device

(76) Inventor: Charles E. Schinner, Windsor, CO (US)

Correspondence Address: HEWLETT-PACKARD COMPANY, Intellectual Property Administration, P.O. Box 272400, Fort Collins, CO, 80527-2400, US

(21) Appl. No.: 09/962,050

(22) Filed: Sep. 25, 2001

(51) Int. Cl. H04N 5/76

(52) U.S. Cl. 348/231.6

(57) ABSTRACT

A handheld electronic device, such as an electronic imaging device, includes the capability of storing personalization modes for different users of the device or for different photographic situations. The personalization modes store values for all operational parameters, such as focus mode, strobe mode, and picture quality. The personalization modes may be stored in association with different user identifiers or with different photographic situation identifiers. A user of the device is able to set all of the operational parameter values of the device according to the user's preference by simply selecting the appropriate user or photographic situation identifier.

### FIELD OF THE INVENTION

The present invention relates generally to handheld electronic devices, such as electronic imaging devices, and more particularly to a handheld electronic device that allows a user to selectively modify all variable device option parameters, and to save the user-selective modifications either as a power-on default setting or as a user-specific “personality mode” setting.

### BACKGROUND OF THE INVENTION

Handheld electronic devices such as digital still cameras, camcorders, or even electronic cameras that use conventional silver halide photographic film, have many operational parameters that are variable. For instance, the auto-exposure program (i.e., shutter speed), aperture, focus mode (manual or auto-focus), strobe mode, auto exposure compensation, auto white balance, LCD display brightness/contrast, picture mode (single frame, multi-frame, video), picture quality (i.e., compression and resolution settings), etc., are operational parameters of the electronic imaging device that can be changed to various values, or changed between on and off modes.

When the imaging device is first powered-on, the various operational parameters must be initialized to some value or mode in order for the device to function. The various operational parameters are typically determined by the designer of the device and set at the factory during manufacture of the device as factory default values. The default values are stored in a non-volatile storage medium or memory, and upon power-on of the imaging device the values are retrieved from the non-volatile memory and loaded into the working memory of the processor of the electronic imaging device. However, such default settings may not represent the optimal settings for a particular photographic situation, or the preferred settings for a particular user of the device. Consequently, according to the prior art, a user is required to manually select and change upon power-up each operational parameter whose default setting is other than the user's preferred setting. Furthermore, according to the prior art only a select number of configuration parameters are capable of being modified by the user. Still further, according to the prior art, whenever a photographic situation changes, the user must individually modify each operational parameter that needs to be changed to conform to the new photographic situation. The same would be true when there are multiple users of the same electronic imaging device, such as multiple family members, etc. Whenever a different user desires to use the imaging device, that user must manually and individually modify the setting of each of the operational parameters to her own preferences.

There thus exists a need in the art for improvements to handheld electronic devices to eliminate the shortcomings mentioned above.

### SUMMARY OF THE INVENTION

The present invention eliminates the shortcomings in the prior art and provides a significant advance in the art, by providing an improved handheld electronic device.

Specifically, according to one preferred embodiment, the present invention provides a handheld electronic device, such as an electronic imaging device, including a processor for controlling operation of said handheld electronic device according to program instructions and operational parameter values; a storage medium for storing operational parameter values, including a power-on storage area which stores initial operational parameter values that are loaded into a working memory of said processor upon initial powering-on of said handheld electronic device; and at least one personalization mode storage area which stores user-selected preferred operational parameter values that are selectively loaded into memory upon user selection after powering-on of said handheld electronic device.

### BRIEF DESCRIPTION OF THE DRAWINGS

FIG. 1 is a block diagram of a digital electronic imaging device according to a preferred embodiment of the invention;

FIG. 2 is a detail of a storage medium of the device of FIG. 1;

FIGS. 3A and 3B are flow diagrams of methods of making modifications to various device configuration option settings according to one embodiment of the invention;

FIG. 4 is a flow diagram of a method of selecting a personalization mode of device configuration according to one embodiment of the present invention; and

FIG. 5 is a flow diagram of a method of resetting configuration options to their original factory default settings according to one embodiment of the present invention.

### DETAILED DESCRIPTION OF THE PREFERRED EMBODIMENTS

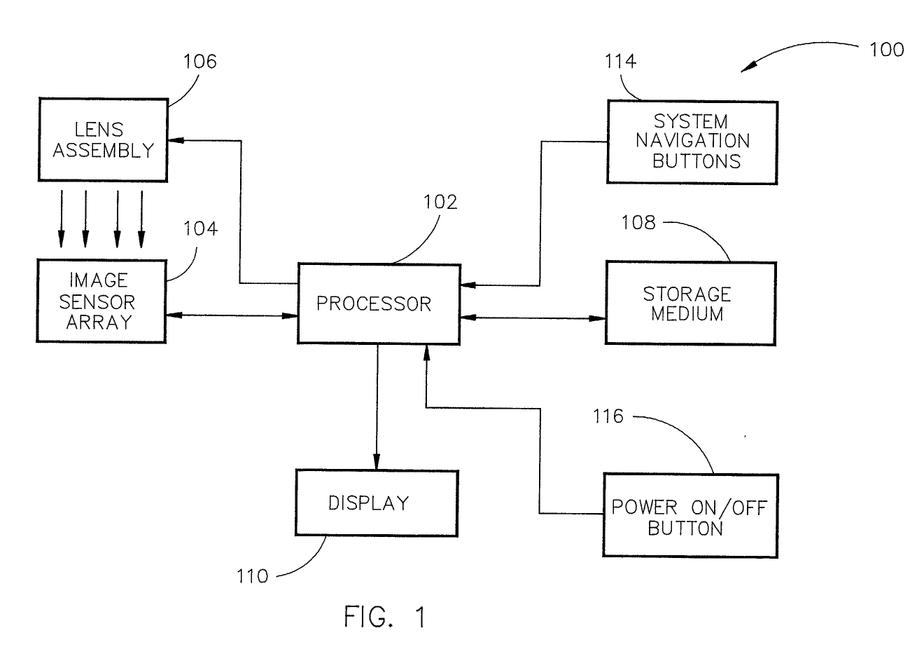

FIG. 1 is a block diagram of the components of an electronic imaging device 100 according to one preferred embodiment of the invention. For purposes of explanation, the invention will be described with respect to a digital still image camera. However, as explained above, the invention is not limited to an electronic imaging device, but is equally applicable to any handheld electronic device having variable operational parameter settings, such as a video recording device, a conventional silver halide photographic film camera with electronic control, a personal digital assistant (PDA), a pager or cellular telephone, etc.

The camera 100 includes a processor 102, such as a microprocessor, CPU or similar device capable of executing mathematical or logic operations on data in response to program instructions. The camera further includes an image sensor array 104, such as a CCD (charge-coupled device) array, CMOS sensor array, or equivalent image sensing device; a lens assembly 106 for focusing light reflected from a scene or object of interest onto the image plane of the image sensor array 104; a display 110 such as an LCD or similar type display; and a storage medium 108.

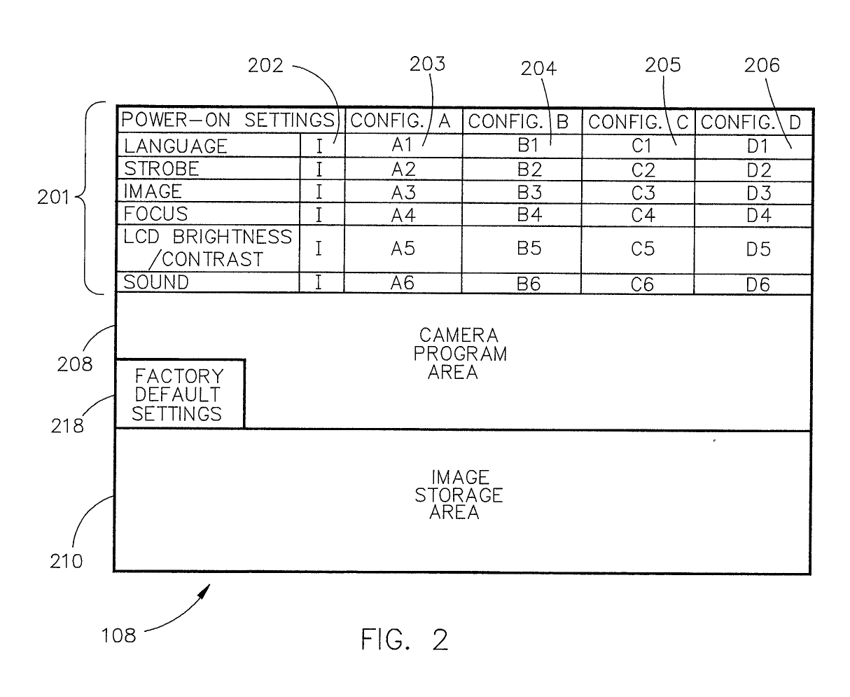

For purposes of the invention, the storage medium 108 may include both non-volatile internal memory and removable memory. Furthermore, the storage medium 108 may include devices such as flash memory, random access memory (RAM), read-only memory (ROM), flash memory, a memory stick, or similar solid state memory for storing image data from the image sensor device (as well as secondary data relating to stored images). The storage medium 108 may additionally be employed for storing device operational programs and various operational parameter settings, as will be discussed below in conjunction with FIG. 2.

The camera 100 further includes one or more system navigation buttons 114, such as arrow buttons, scrolling buttons, select buttons, etc. for selecting and using the various functional capabilities of the camera, and a power on/off button 116. The camera 100 would further include a shutter button (not shown) for capturing images.

As shown in FIG. 2, the storage medium 108 includes an operational parameters storage area 201 for storing various operational parameter settings for the operation of the handheld electronic device, including, but not limited to, language setting, strobe setting, image quality, focus mode, LCD brightness, contrast, and sound setting. Additional configuration settings that can be modified according to the invention include picture count, auto white balance, auto exposure compensation, instant review mode, metering area, metering type, and auto-focus area, for example.

The operational parameters storage area 201 may include default (initial) power-on settings 202, and includes configuration storage areas 203-206 for storing configuration mode settings, where each configuration mode corresponds to a particular user or mode identifier. For example, the four modes could be “MARY”, “JOE”, “HEATHER”, and “DAD”, or could be “indoor”, “outdoor”, “action”, and “close-ups”. Although four configuration mode storage areas 203-206 are shown, it should be understood that any number of such areas may be provided.

For purposes of the invention, the configuration mode storage areas 203-206 are designated as user identifier areas, but it will be noted that the different areas equally could correspond to different photographic situation identifiers, and be labeled as such by the user, as illustrated in the previous paragraph. As examples, different photographic situations would be identified as bright daylight, moving subject, overcast, night, portrait, close-up, etc.

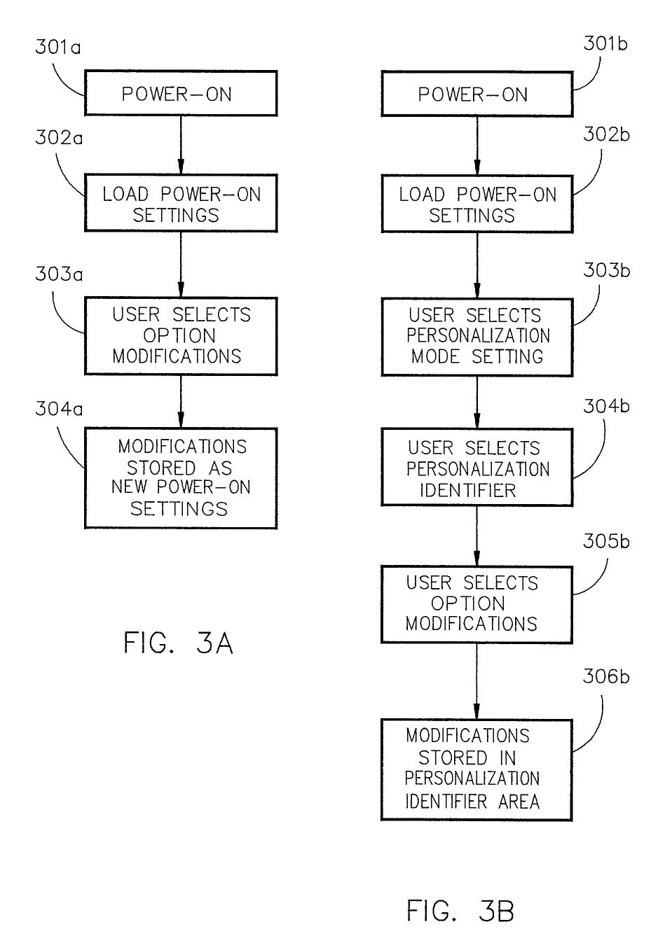

The storage medium also includes an image storage area 210 for storing captured image data, and a camera program area 208 for storing operational programs and instructions for execution by the processor. In addition, the camera program area 208 may include a factory default settings area 218 (instead of the default power-on settings 202) that is programmed at the factory with default power-on initialization values. In the absence of any user-selected operational parameter values, the factory default settings will be used. Moreover, the factory default settings may be one of the choices presented to the user, or may be automatically loaded after a predetermined power-up initialization time period expires without a user selection occurring (discussed in detail in the text accompanying FIG. 3B).

Although the storage medium 108 is shown as one contiguous block, it should be understood that various memory configurations may be employed. For example, the operational parameters storage area 201 may be part of the camera program area 208, may be part of the image storage area 210, or may be located on a distinct and separate storage device. In addition, the various storage areas may comprise different types of memory, including RAM, ROM, erasable programmable ROM, flash memory, etc.

Another variable aspect is the physical location of the storage medium 108. The storage medium 108 may be an internal memory. Alternatively, the operational parameters storage area 201, the camera program area 208, and the factory default settings 218 may be located in an internal memory, while the image storage area 210 may be located on a removable memory, such as a flash card or smart card. In yet another alternative, all of the storage areas may be on a removable memory, with the removable memory thereby providing a portable personalization capability to the user.

According to one embodiment as shown in FIG. 3A, at step 301a the device is powered-on, such as by pressing a power button of the device.

After powering on, the processor at step 302a retrieves from the storage area 202 all of the initial power-on settings for the various camera configuration parameters, and loads the settings into working memory.

When a user desires to modify some or all of the initial power-on settings, the user at step 303a may select a parameter modification function by using a button or other input device provided as part of the user interface or system navigation buttons 114. At this time, a menu is displayed in the display 110, allowing the user to select and modify the various operational parameters of the camera.

In step 304a, the user may change the settings by manipulation of the system navigation buttons, causing the desired settings to be displayed in the display menu, and then select a displayed setting to be saved in the memory area 202. In this way, the user may modify the settings of all of the configuration parameters of the camera according to the user's preference, such that upon the next power-on of the device, the user's desired settings would automatically be loaded into the working memory of the processor.

Alternatively, at a power-down, the device may automatically save the settings as a new set of operational parameters. Further, if the user has changed any settings, the device may prompt the user and ask whether the user wants to save the changes as a new set. In yet another alternative, the user may optionally load and store settings from another electronic device (such as a personal computer (PC), a personal digital assistant (PDA), etc.). Moreover, externally generated settings may be imported into the device through a removable memory medium, such as from a flash card, smart cart, etc.

As shown in FIG. 3B, according to the invention the user also may select a personalization mode setting of the camera, in which the user sets specific values of the operational parameters of the camera for a specific user or photographic situation identifier. At step 301b the device is powered-on, as previously discussed.

At step 302b the power-on settings are retrieved from the storage medium and loaded into the processor's working memory. The loading preferably includes loading a particular set of user-selected operational parameters, assuming that the user has selected from among various stored sets of operational parameters (in the configuration mode storage areas 203-206). However, if the user has not specified the operational parameters to be loaded, the method may optionally perform one of several choices. The device may choose a first set of operational parameters (i.e., the first occurring set of parameters in the configuration mode storage area 203). Alternatively, the device may load a most often used set of operational parameters, may load from factory default settings, or may choose to load a set of user-defined operational parameters if only one such set exists (and load default values otherwise). These various optional selection steps may be performed after the expiration of a predetermined power-up initialization time period. Therefore, the device may take some defined action in a situation where the time period has expired without a user selection occurring.

At step 303b, the user selects a personalization mode setting of the camera, whereupon a user identifier menu will be displayed to the user.

At step 304b, the user selects a particular personalization identifier, such as “CONFIG 1” for example.

At step 305b, the user selects the various configuration option modifications according to the user's preference.

At step 306b, the selected modifications are stored in the personalization storage area 203. Such settings are designated as values “A1”, “A2”, etc., in the configuration mode storage area 203. Similarly, for other configuration identifiers, different values “B,” “C” or “D” would be stored in the corresponding configuration mode storage areas 204, 205 or 206. In this regard, it is noted that any configuration option that is not modified by the user will have the initial setting value “I” from the default power-on settings area 202 or from the factory default settings area 218.

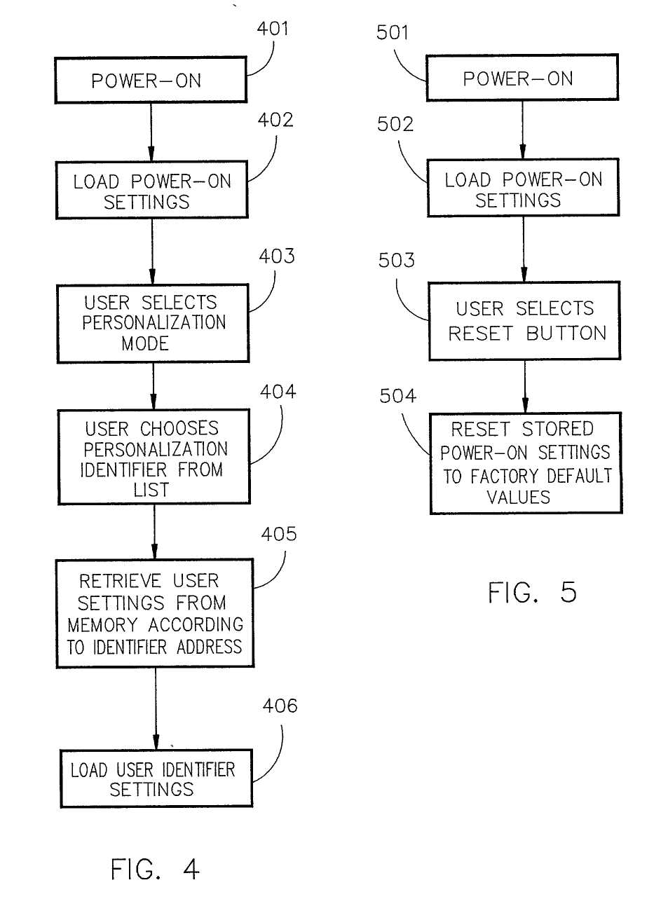

FIG. 4 shows a flow operation in which a user selects a personalization mode setting upon power-on of the device. At step 401, the electronic imaging device is powered-on.

At step 402, the default power-on settings from storage area 202 are loaded into the working memory of the processor.

At step 403, the user selects a personalization mode of the imaging device, using the system navigation buttons 114 or equivalent user interface.

Upon selection of the personalization mode, at step 404 a list of presently stored identifiers (either user identifiers or photographic situation identifiers) is displayed on the display 110. In response to this display, the user selects a desired identifier from which corresponding preferred camera configuration settings will be retrieved.

At step 405, the processor retrieves the stored personalized configuration settings corresponding to the user identifier address selected by the user. For example, if the user selected CONFIG 3 in step 404, then at step 405 the processor would retrieve configuration settings “C1”, “C2”, etc., from memory storage area 205.

At step 406, the device loads the selected configuration settings, i.e., a set of operational parameters.

FIG. 5 illustrates a process by which the user is able to reset the camera's configuration settings to their original factory default values. At step 501, the imaging device is powered on.

At step 502, the power-on configuration settings are loaded into the working memory of the processor from the storage area 202.

At step 503, the user selects a configuration setting reset function by actuating an appropriate navigation button or other user input device.

At step 504, the initial factory configuration settings are read from a permanent memory storage area (not shown) and are rewritten to the power-on operational parameter value storage area 202, overwriting the previously stored values.

What is claimed is:

1. A handheld electronic device comprising:
a processor for controlling operation of said handheld electronic device according to program instructions and operational parameter values; and
a storage medium for storing operational parameter values, including a power-on storage area which stores initial operational parameter values that are loaded into a working memory of said processor upon initial powering-on of said handheld electronic device, and at least one personalization mode storage area which stores user-selected preferred operational parameter values that are selectively loaded into memory upon user selection after powering-on of said handheld electronic device.

2. A handheld electronic device as set forth in claim 1, wherein said operational parameter values include a strobe mode setting, a focus mode setting, a picture taking mode setting, a picture count mode setting, an auto white balance mode setting, an exposure compensation mode setting, a metering area, a metering type, or an auto focus area.

3. A handheld electronic device as set forth in claim 1, wherein said processor loads a default set of initial operational parameter values if a predetermined power-up initialization time period expires without a user selection occurring.

4. A handheld electronic device as set forth in claim 1, wherein said processor loads a default set of operational parameter values in an absence of a user selection.

5. A handheld electronic device as set forth in claim 1, wherein said processor loads a first set of operational parameter values in an absence of a user selection.

6. A handheld electronic device as set forth in claim 1, wherein said processor loads said user-selected preferred operational parameter values if said at least one personalization mode storage area includes only one set of user-selected preferred operational parameter values.

7. A handheld electronic device as set forth in claim 1, wherein said personalization mode storage area stores said values according to user identifiers.

8. A handheld electronic device as set forth in claim 1, wherein said personalization mode storage area stores said values according to photographic situation identifiers.

9. A handheld electronic device as set forth in claim 1, wherein said handheld electronic device comprises an electronic imaging device.

10. A method of operating a handheld electronic device, comprising the steps of:
providing a storage medium having a first storage area for storing power-on operational parameter values, and having a second storage area for storing at least one personalization mode containing user-selected operational parameter values;
loading said power-on operational parameter values into a working memory of a processor of said handheld electronic device upon initial powering-on of said handheld electronic device; and
loading said user-selected operational parameter values into said working memory upon selection of said personalization mode by a user after said handheld electronic device has been powered-on.

11. A method as set forth in claim 10, wherein said operational parameter values include a strobe mode setting, a focus mode setting, a picture taking mode setting, a picture count mode setting, an auto white balance mode setting, an exposure compensation mode setting, a metering area, a metering type, or an auto focus area.

12. A method as set forth in claim 10, wherein the loading step loads a default set of initial operational parameter values if a predetermined power-up initialization time period expires without a user selection occurring.

13. A method as set forth in claim 10, wherein the loading step loads a default set of operational parameter values in an absence of a user selection.

14. A method as set forth in claim 10, wherein the loading step loads a first set of operational parameter values in an absence of a user selection.

15. A method as set forth in claim 10, wherein the loading step loads said user-selected operational parameter values if a personalization mode storage area includes only one set of user-selected preferred operational parameter values.

16. A method as set forth in claim 10, wherein said personalization mode storage area stores said values according to user identifiers.

17. A method as set forth in claim 10, wherein said personalization mode storage area stores said values according to photographic situation identifiers.

18. A method as set forth in claim 10, wherein said handheld electronic device comprises an electronic imaging device.
